(19) United States
(12) Patent Application Publication
(10) Pub. No.: US 2005/0268716 A1
(43) Pub. Date: Dec. 8, 2005

(54) BUILT IN TEST FOR MEMS VIBRATORY TYPE INERTIAL SENSORS

(75) Inventors: Albert C. Hrovat, Lino Lakes, MN (US); Randolph G. Hartman, Plymouth, MN (US); Thomas A. Savard, Arden Hills, MN (US); William P. Platt, Forest Lake, MN (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/160,062

(22) Filed: Jun. 7, 2005

Related U.S. Application Data
(60) Provisional application No. 60/578,097, filed on Jun. 8, 2004.

(51) Int. Cl. G01P 15/08

(52) U.S. Cl. 73/504.12

(57) ABSTRACT

The present invention provides a MEMS vibratory type inertial sensor that has some level of built in test to help improve the reliability by helping to identify erroneous or misleading data provided by the inertial sensor. In one illustrative embodiment, a test signal is injected into one or more of the inputs of the MEMS vibratory type inertial sensor, where the test signal produces a test signal component at one or more of the MEMS vibratory type inertial sensor outputs. The test signal component is then monitored at one or more of the outputs. If the test signal component matches at least predetermined characteristics of the original test signal, it is more likely that the MEMS vibratory type inertial sensor is operating properly and not producing erroneous or misleading data. In some embodiments, the test signal is provided and monitored during the normal functional operation of the MEMS vibratory type inertial sensor, thereby providing on-going built in test.

### FIELD OF THE INVENTION

This invention relates generally to MEMS vibratory type inertial sensors such as MEMS gyros and MEMS accelerometers, and more specifically to MEMS vibratory inertial sensors with build in test.

### BACKGROUND

MEMS vibratory type inertial sensors are used in a wide variety of applications. For many of these applications, a high degree of reliability is desired. For example, in automotive stability control systems, reliable inertial sensors are desirable to reduce erroneous or misleading data, which in some cases, could lead to loss of control of the automobile. What would be desirable is a MEMS vibratory type inertial sensor that has some level of built in test to help improve the reliability by helping to identify erroneous or misleading data provided by the inertial sensor.

### SUMMARY

The present invention provides a MEMS vibratory type inertial sensor that has some level of built in test to help improve the reliability by helping to identify erroneous or misleading data provided by the inertial sensor. In one illustrative embodiment, a test signal is injected into one or more of the inputs of the MEMS vibratory type inertial sensor, where the test signal produces a test signal component at one or more of the MEMS vibratory type inertial sensor outputs. The test signal component is then monitored at one or more of the outputs. If the test signal component matches at least predetermined characteristics of the original test signal, it is more likely that the MEMS vibratory type inertial sensor is operating properly and not producing erroneous or misleading data. In some embodiments, the test signal is provided and monitored during the normal functional operation of the MEMS vibratory type inertial sensor, thereby providing on-going built in test.

### BRIEF DESCRIPTION OF THE DRAWINGS

FIG. 1 is a schematic view of a MEMS-type gyroscope in accordance with the present invention; and

FIG. 2 is a schematic view of an illustrative MEMS-type gyroscope with a level of build in test.

### DESCRIPTION

The following description should be read with reference to the drawings, in which like elements in different drawings are numbered in like fashion. The drawings, which are not necessarily to scale, depict selected embodiments and are not intended to limit the scope of the invention. Although examples of construction, dimensions, and materials may be illustrated for the various elements, those skilled in the art will recognize that many of the examples provided have suitable alternatives that may be utilized.

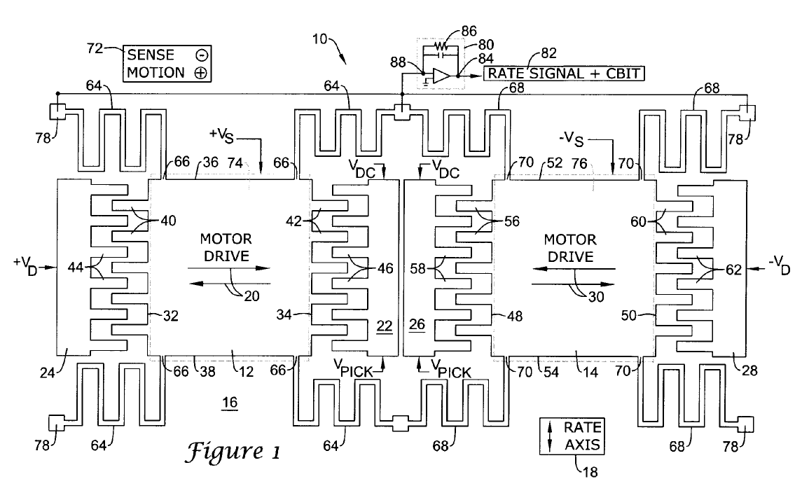

For illustrative purposes, and referring to FIG. 1, a MEMS-type gyroscope 10 will be described in detail. However, it should be recognized that the present invention can be applied to a wide variety of MEMS vibratory type inertial sensors such as MEMS gyros and MEMS accelerometers, as desired.

Gyroscope 10, illustratively a vibratory rate gyroscope, includes a first proof mass 12 and second proof mass 14, each of which are adapted to oscillate back and forth above an underlying support substrate 16 in a drive plane orthogonal to an input or “rate” axis 18 of the gyroscope in which inertial motion is to be determined. As indicated generally by the right/left set of arrows 20, the first proof mass 12 can be configured to oscillate back and forth above the support substrate 16 between a first shuttle mass 22 and first drive electrode 24, both of which remain stationary above the support substrate 16 to limit movement of the first proof mass 12. The second proof mass 14, in turn, can be configured to oscillate back and forth above the support substrate 16 in a similar manner between a second shuttle mass 26 and second drive electrode 28, but in most cases 180° degrees out-of-phase with the first proof mass 12, as indicated generally by the left/right set of arrows 30.

The first proof mass 12 can include a thin plate or other suitable structure having a first end 32, a second end 34, a first side 36, and a second side 38. Extending outwardly from each end 32,34 of the first proof mass 12 are a number of comb fingers 40,42. Some of the comb fingers can be used to electrostatically drive the first proof mass 12 in the direction indicated by the right/left set of arrows 20. In the illustrative gyroscope 10 depicted in FIG. 1, for example, a first set of comb fingers 40 extending outwardly from the first end 32 of the first proof mass 12 can be interdigitated with a corresponding set of drive comb drive fingers 44 formed on the first drive electrode 24. A second set of comb fingers 42 extending outwardly from the second end 34 of the first proof mass 12, in turn, can be interdigitated with a corresponding set of comb fingers 46 formed on the first shuttle mass 22. In some embodiments, the set of comb fingers 46 may be used to sense the motion of the first proof mass 12.

The second proof mass 14 can be configured similar to the first proof mass 12, having a first end 48, a second end 50, a first side 52, and a second side 54. A first set of comb fingers 56 extending outwardly from the first end 48 of the second proof mass 16 can be interdigitated with a corresponding set of comb fingers 58 formed on the second shuttle mass 26. In some embodiments, the set of comb fingers 58 may be used to sense the motion of the second proof mass 14. A second set of comb fingers 60 extending outwardly from the second end 50 of the second proof mass 14, in turn, can be interdigitated with a corresponding set of drive comb fingers 62 formed on the second drive electrode 28.

The first and second proof masses 12,14 can be constrained in one or more directions above the underlying support structure 16 using one or more suspension springs. As shown in FIG. 1, for example, the first proof mass 12 can be anchored or otherwise coupled to the support substrate 16 using a first set of four suspension springs 64, which can be connected at each end 66 to the four corners of the first proof mass 12. In similar fashion, the second proof mass 14 can be anchored to the underlying support substrate 16 using a second set of four springs 68, which can be connected at each end 70 to the four corners of the second proof mass 14.

In use, the suspension springs 64,68 can be configured to isolate oscillatory movement of the first and second proof masses 12,14 to the direction indicated generally by the right/left set of arrows 20,30 to reduce undesired perpendicular motion in the direction of the rate axis 18, and to reduce quadrature motion in the direction of the sensing motion 72. In addition to supporting the proof masses 12,14 above the support substrate 16, the suspension springs 64,68 can also be configured to provide a restorative force when the drive voltage signal passes through the zero point during each actuation cycle.

A drive voltage V_{D} can be applied to the first and second drive electrodes 24,28, inducing an electrostatic force between the interdigitated comb fingers that causes the comb fingers to electrostatically move with respect to each other. The drive voltage V_{D} can be configured to output a time-varying voltage signal to alternate the charge delivered to the comb fingers, which in conjunction with the suspension springs 64,68, causes the first and second proof masses 12,14 to oscillate back and forth in a particular manner above the support substrate 16. Typically, the drive voltage V_{D} will have a frequency that corresponds with the resonant frequency of the first and second proof masses 12,14 (e.g. 10 KHz), although other desired drive frequencies can be employed, if desired.

A pair of sense electrodes 74,76 can be provided as part of the sensing system to detect and measure the out-of-plane deflection of the first and second proof masses 12,14 in the sense motion direction 72 as a result of gyroscopic movement about the rate axis 18. As shown by the dashed lines in FIG. 1, the illustrative sense electrodes 74,76 can include a thin, rectangular (or other) shaped electrode plate positioned underneath the proof masses 12,14 and oriented in a manner such that an upper face of each sense electrode 74,76 is positioned vertically adjacent to and parallel with the underside of the respective proof mass 12,14. The sense electrodes 74,76 can be configured in size and shape to minimize electrical interference with the surrounding comb fingers 40,42,56,60 to prevent leakage of the drive voltage source V_{D} into the sense signal.

A sense bias voltage V_{S} applied to each of the sense electrodes 74,76 can be utilized to induce a charge on the first and second proof masses 12,14 proportional to the capacitance between the respective sense electrode 74,76 and proof mass 12,14. The sense electrode 74,76 and the first and second proof masses 12,14 preferably include a conductive material (e.g. a silicon-doped conductor, metal or any other suitable material), allowing the charge produced on the sense electrode 74,76 vis-à-vis the sense bias voltage V_{S} to be transmitted to the proof mass 12,14.

During operation, the Coriolis force resulting from rotational motion of the gyroscope 10 about the rate axis 18 causes the first and second proof masses 12,14 to move out-of-plane with respect to the sense electrodes 74,76. When this occurs, the change in spacing between the each respective sense electrode 74,76 and proof mass 12,14 induces a change in the capacitance between the sense electrode 74,76 and proof mass 12,14, which can be measured as a charge on the proof masses 12,14 using the formula:

q=ε₀AVₛ/D

wherein A is the overlapping area of the sense electrode and proof mass, V_{S} is the sense bias voltage applied to the sense electrode, ε₀ the dielectric constant of the material (e.g. vacuum, air, etc.) between the sense electrodes and the proof masses, and D is the distance or spacing between the sense electrode 74,76 and respective proof mass 12,14. The resultant charge received on the proof mass 12,14 may be fed through or across the various suspension springs 64,68 to a number of leads 78. The leads 78, in turn, can be electrically connected to a charge amplifier 80 that converts the charge signals, or currents, received from the first and second proof masses 12,14 into a corresponding rate signal 82 that is indicative of the Coriolis force.

To help balance the input to the charge amplifier 80 at or about zero, the sense bias voltage V_{S} applied to the first proof mass 12 can have a polarity opposite to that of the sense bias voltage V_{S} applied to the second proof mass 14. In certain designs, for example, a sense bias voltage V_{S} of +5V and −5V, respectively, can be applied to each of the sense electrodes 74,76 to prevent an imbalance current from flowing into the output node 84 of the charge amplifier 80. To help maintain the voltage on the proof masses 12,14 at about virtual ground, a relatively large value resistor 86 can be connected across the input 88 and output nodes 86 of the charge amplifier 80, if desired.

A motor bias voltage V_{DC} can be provided across the first and second shuttle masses 22,26 to detect and/or measure displacement of the proof masses 12,14 induced via the drive voltage source V_{D}. A motor pickoff voltage V_{PICK} resulting from movement of the comb fingers 42,56 on the first and second proof masses 12,14 relative to the comb fingers 46,58 on the first and second shuttle masses 22,26 can be used to detect/sense motion of the first and second proof masses 12,14.

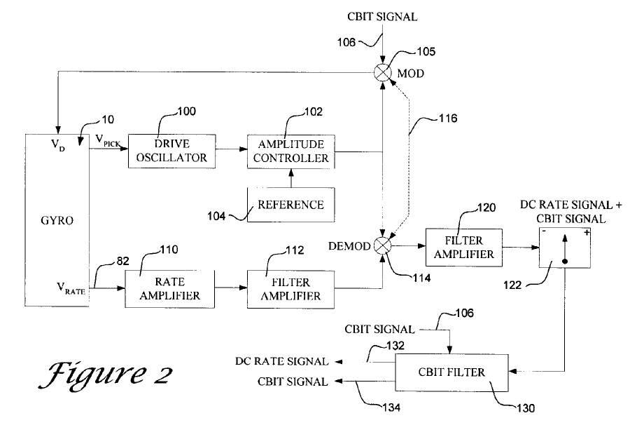

FIG. 2 is a schematic view of an illustrative MEMS-type gyroscope with a certain level of build in test. The gyroscope of FIG. 1 is shown in block form as gyro block 10. In the illustrative embodiment, a drive oscillator 100 receives the motor pickoff voltage V_{PICK} discussed above with respect to FIG. 1. While only one motor pickoff voltage is shown in FIG. 2, it is contemplated that in some embodiments, the drive oscillator 100 may be configured to receive a motor pickoff voltage V_{PICK} from each of the proof masses of FIG. 1. However, for simplicity, the embodiment shown in FIG. 2 only shows and discusses the operation of one of the proof masses.

The drive oscillator 100 uses the motor pickoff voltage V_{PICK} to provide the next drive motor cycle. As noted above, the drive motor signal can be configured to output a time-varying voltage signal to alternate the charge delivered to the comb fingers, which in conjunction with the suspension springs 64,68, causes the first and second proof masses 12,14 to oscillate back and forth in a particular manner above the support substrate 16 (see FIG. 1). Typically, the drive voltage V_{D} will have a frequency that corresponds with the resonant frequency of the first and second proof masses 12,14 (e.g. 10 KHz), although other desired drive frequencies can be employed, if desired.

To help control the amplitude of the voltage, the output of the drive oscillator 100 may be provided to an amplitude controller 102. The amplitude controller 102 receives a reference amplitude from reference 104. In a gyro that does not have built in test, the output of the amplitude controller 102 may be provided directly as the drive voltage V_{D} to one of the proof masses. However, and in accordance with one illustrative embodiment of the present invention, the output of the amplitude controller 102 may be provided to a modulator 105, which modulates the output of the amplitude controller 102 and a test signal 106. The test signal 106 may be a continuously running built in test (CBIT) AC signal, and may have a frequency that is substantially higher or substantially lower than the motor drive resonance frequency. In one illustrative embodiment, the test signal 106 has a frequency of 50 Hz and the motor drive signal has a frequency of about 10 KHz, however other frequencies may be used. In some cases, the amplitude of the test signal 106 may be made to substantially match an expected coriolis rate voltage (e.g. V_{RATE} 82), but this is not required in all embodiments

After the test signal 106 is modulated by modulator 105, the result is provided to the gyro 10 as the drive voltage V_{D}. The drive voltage V_{D} thus has a component that corresponds to the test signal 106 and a component that corresponds to the output of the amplitude controller 102. The component of the drive voltage V_{D} that corresponds to the test signal 106 preferably has a frequency that is sufficiently off any resonant modes of the proof masses such that it has little or no effect on the electrostatic drive of the proof masses. However, in the illustrative embodiment, it is capacitively coupled to the proof masses (and in some cases to the sense plates), and ultimately to the charge amplifier 80, which converts the charge signals, or currents, received from the first and second proof masses 12,14 into a corresponding rate signal 82 that is indicative of the Coriolis force. Thus, in the illustrative embodiment, the output 82 of the charge amplifier 80 may includes a component that corresponds to the experienced Coriolis force and a component that corresponds to the capacitively coupled test signal 106.

In the illustrative embodiment, the output 82 of the charge amplifier 80 may be provided to a rate amplifier 110, which amplifies the signal. The output of the rate amplifier 110 may be provided to a filter amplifier 112, which performs both a filtering and amplifying function. The output of the filter amplifier 112 may then be demodulated using the output of the amplitude controller 104, as shown at 114. In the illustrative embodiment, the test signal 106 is originally modulated using the output of the amplitude controller 104 as a reference, and the output of the filter amplifier 112 is demodulated using the same signal, as indicate by dashed line 116. This may help keep the modulated test signal 106 relatively in phase with the rate signal 82 that is indicative of the Coriolis force.

In the illustrative embodiment, the demodulated signal is provided to another filter amplifier 120, and the result is a DC rate bias signal with a superimposed component of the test signal, as shown at 122. This signal is passed to yet another filter 130 that separates the component of the test signal from the DC rate bias signal. If the component of the test signal 134 matches at least selected characteristics of the original test signal 106, it is more likely that the gyro 10 is operating properly and not producing erroneous or misleading data.

In some embodiments, the filter 130 may be simply a high pass filter and a low pass filter. For example, a high pass filter may pass the component of the test signal 134 while the low pass filter may pass the DC rate bias signal 132. In other embodiments, however, the filter 130 may be a more sophisticated filter, such as an adaptive filter. One such adaptive filter is described in U.S. Pat. No. 5,331,402, which is assigned to the assignee of the present invention. In some embodiments, the adaptive filter may receive the original test signal 106 to help separate the component of the test signal 134 from the DC rate signal 132. In some cases, the adaptive filter may be configured to “adapt” relatively slowly relative to the expected rate of change of the DC rate signal 132. For example, the adaptive filter may have a time constant of 60 seconds, or any other suitable time constant as desired.

The DC rate signal 132 and the separated component of the test signal 134 may be converted to digital signals for subsequent processing and/or analysis. In some embodiment, the DC rate signal 132 may be sampled at 100 Hz, and the separated component of the test signal 134 may be sampled at 200 Hz, although other sample rates may also be used if desired.

As can be seen, the test signal 106 may be continuously supplied, and thus the operation of the gyro may be continuously monitored and/or tested. This may help improve the reliability of the gyro by helping to identify erroneous or misleading data provided by the gyro.

Rather than injecting the test signal 106 into the motor drive signal, it is contemplated that the test signal 106 may be injected onto the sense plates, if desired. When so provided, the test signal 106 is capacitively coupled into the proof masses, and superimposed on the output 82 of the charge amplifier 80, as described above. This configuration may also provide a certain level of built in test, and help improve the reliability of the gyro by helping to identify erroneous or misleading data provided by the gyro.

1. A MEMS vibratory type inertial sensor having a number of inputs and a number of outputs, comprising:
an injector for injecting a test signal into one or more of the inputs of the MEMS vibratory type inertial sensor, the test signal producing a test signal component at one or more of the outputs; and
a separator coupled to one or more of the outputs for separating the test signal component from the one or more outputs.

2. The MEMS vibratory type inertial sensor of claim 1 further comprising:
a proof mass that moves back and forth along a motor drive axis;
a motor drive electrode for electrostatically driving the proof mass along the motor drive axis, the motor drive electrode being driven by a motor drive signal;
a sense plate positioned adjacent the proof mass, the sense plate biased at a sense potential; and
wherein the test signal is injected into the motor drive electrode.

3. The MEMS vibratory type inertial sensor of claim 2 further comprising a modulator for modulating the test signal and the motor drive signal.

4. The MEMS vibratory type inertial sensor of claim 3 wherein at least one of the outputs includes a rate output, and during operation, the rate output includes a signal that includes a component that is related to the rate of rotation of the MEMS vibratory type inertial sensor about a rate axis and a component that is related to the injected test signal.

5. The MEMS vibratory type inertial sensor of claim 4 further comprising a demodulator for demodulating the signal at that rate output with the motor drive signal.

6. The MEMS vibratory type inertial sensor of claim 5 wherein the separator Includes one or more filters for separating the test signal component from the signal at the rate output.

7. The MEMS vibratory type inertial sensor of claim 1 further comprising:
a proof mass that moves back and forth along a motor drive axis;
a motor drive electrode for electrostatically driving the proof mass along the motor drive axis, the motor drive electrode being driven by a motor drive signal;
a sense plate positioned adjacent the proof mass, the sense plate biases at a sense potential; and
wherein the test signal is injected into the sense plate.

8. A MEMS vibratory type inertial sensor comprising:
a motor drive driven by a motor drive signal;
a proof mass electrostatically driven by the motor drive;
an injector for injecting a test signal onto the motor drive signal;
a rate sensor for sensing coriolis movement of the proof mass, the rate sensor providing a rate signal that has a component that relates to coriolis movement of the proof mass and a component that relates to the test signal; and
a separator for separating the rate signal Into the component that relates to the test signal and the component that relates to coriolis movement of the proof mass.

9. The MEMS vibratory type inertial sensor according to claim 8 wherein the Injector Includes a modulator for modulating the test signal with the motor drive signal.

10. The MEMS vibratory type inertial sensor according to claim 9 further comprising a demodulator for demodulating the rate signal resulting in a demodulated rate signal, and wherein the separator separates the demodulated rate signal into a component that relates to the test signal and a component that relates to coriolis movement of the proof mass.

11. A method for monitoring a MEMS vibratory type inertial sensor, the method comprising the steps of:
injecting a test signal into one or more of the inputs of the MEMS vibratory type inertial sensor, the test signal producing a test signal component at one or more of the outputs; and
monitoring the test signal component at the one or more outputs.

12. The method of claim 11 further comprising the step of:
determining that the MEMS vibratory type inertial sensor is functioning if the test signal component matches at least predetermined characteristics with the injected test signal.

13. The method of claim 11 further comprising the steps of:
providing a motor drive signal to a motor drive input of the MEMS vibratory type inertial sensor;
injecting the test signal into the motor drive signal; and
sensing a rate signal provided by the MEMS vibratory type inertial sensor, the rate signal including a component that corresponds to the test signal.

14. A method according to claim 13 further comprising the step of:
determining if the component of the rate signal that corresponds to the test signal matches one or more characteristics of the test signal.

15. A method according to claim 13 further comprising the step of:
separating the component that corresponds to the test signal from the rate signal.

16. A method according to claim 15 wherein the separating step separates the component that corresponds to the test signal from the rate signal using an adaptive filter.

17. A method according to claim 13 wherein the test signal is modulated by the motor drive signal.

18. The method of claim 11 wherein the MEMS vibratory type inertial sensor includes a proof mass that moves back and forth along a motor drive axis, a motor drive electrode for electrostatically driving the proof mass along the motor drive axis, the motor drive electrode being driven by a motor drive signal, and a sense plate positioned adjacent the proof mass, the sense plate biases at a sense potential, wherein the test signal is injected into the sense plate.

19. The method of claim 18 further comprising the step of:
sensing a rate signal provided by the MEMS vibratory type inertial sensor, the rate signal including a component that is related to the movement of the MEMS vibratory type inertial sensor and a component that relates to the test signal.

20. The method of claim 19 further comprising the step of:
separating the component that relates to the movement of the MEMS vibratory type inertial sensor and the component that relates to the test signal.
